(19) United States
(12) Patent Application Publication
(10) Pub. No.: US 2015/0019948 A1
(43) Pub. Date: Jan. 15, 2015

(54) HUB APPARATUS AND METHOD OF USE THEREOF FOR UPDATING MICROSITES

(71) Applicant: Michael D. Roth, Scottsdale, AZ (US)

(72) Inventor: Michael D. Roth, Scottsdale, AZ (US)

(21) Appl. No.: 13/942,044

(22) Filed: Jul. 15, 2013

(51) Int. Cl. G06F 17/24; G06F 17/22

(52) U.S. Cl. CPC G06F 17/243; G06F 17/2247
USPC 715/226

(57) ABSTRACT

The invention comprises a hub apparatus and method of use thereof for generating and/or updating a plurality of microsites. In one case, initially a controller updates a hub with a limited number of parameters common to a large number of microsites. Subsequently, the hub is used to update common parameters across a number of microsites. Updated parameters common to the microsites include: a string of text, microsite information, an image, an animation, a video, a banner, a background, a skin, a rendered image, hidden information, and/or any other microsite element. In another case, microsites are generated with user specific information, such as based on a user profile and/or commonalities between the user profile and products/services offered by a company.

### CROSS REFERENCES TO RELATED APPLICATIONS

This application claims the benefit of:

U.S. provisional patent application No. 61/672,237 filed Jul. 16, 2012; and

U.S. provisional patent application No. 61/746,439 filed Dec. 27, 2012,

all of which are incorporated herein in their entirety by this reference thereto.

### TECHNICAL FIELD OF THE INVENTION

The present invention relates to micro-websites.

### DESCRIPTION OF THE RELATED ART

Microsite

A microsite or a micro-website is a web design term referring to an individual internet web page or a small cluster, such as less about one to nine pages, of websites. Generally, the microsite pages function as a discreet entity within an existing main website, where the website has a domain name or a sub-domain name.

Problem Statement

What is needed is an efficient system for updating a plurality of microsites.

### SUMMARY OF THE INVENTION

The invention comprises an updatable hub used to update material common to a plurality of microsites.

### BRIEF DESCRIPTION OF THE DRAWINGS

A more complete understanding of the present invention is derived by referring to the detailed description and claims when considered in connection with the Figures, wherein like reference numbers refer to similar items throughout the Figures.

FIG. 1 illustrates an updatable hub linked to a plurality of micro-websites;

FIG. 2 illustrates a hub used to update a single microsite as a function of time;

FIG. 3 illustrates a hub used to update a plurality of microsites in a single industry; and

FIG. 4 illustrates a hub used to update microsites in a plurality of distinct industries.

Elements and steps in the figures are illustrated for simplicity and clarity and have not necessarily been rendered according to any particular sequence. For example, steps that are performed concurrently or in different order are illustrated in the figures to help improve understanding of embodiments of the present invention.

### DETAILED DESCRIPTION OF THE PREFERRED EMBODIMENTS

The invention comprises a hub used to update a plurality of microsites.

In one embodiment, the invention comprises a hub apparatus and method of use thereof for updating microsites, where a controller, programmer, or user updates a hub with a limited number of parameters common to a large number of microsites. Subsequently, the hub is used to update common parameters across a number of microsites. Examples of common updateable parameters include a piece of information, a location of the information, and/or a presentation of the information.

HUB

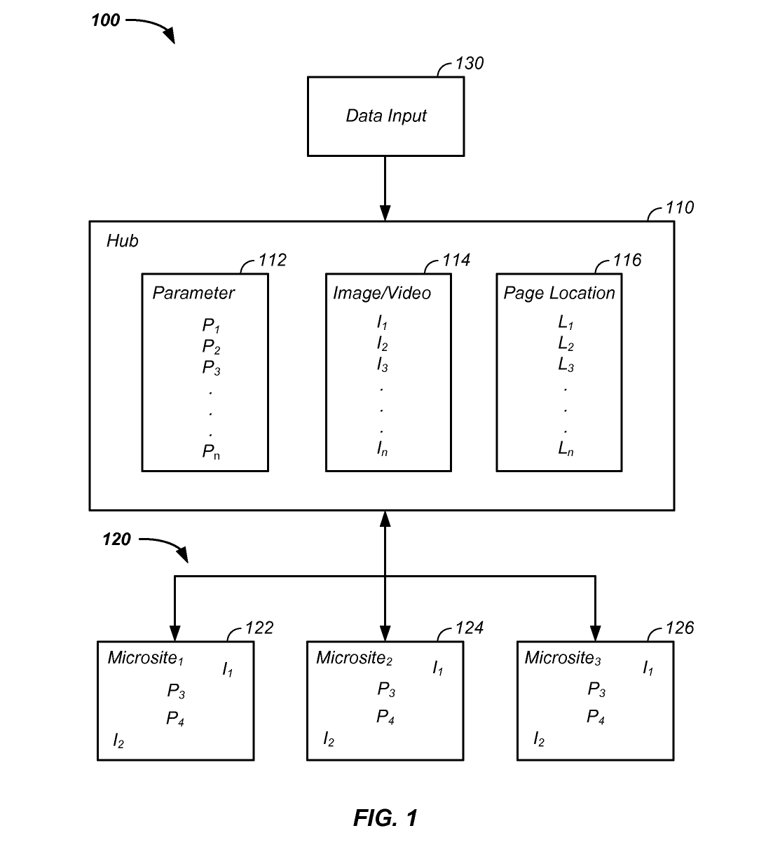

Referring now to FIG. 1, a hub 110 is optionally used to update information common to a plurality of microsites 120. For example, a database within the hub 110 is populated with information or data 130 that is subsequently distributed to and/or implemented within code and/or presentation of a plurality of the microsites 120. Examples of common information or data 130 within microsites 120 that is optionally filled using a database of the hub 110 include any of:
perceived or rendered information, such as:
   textual information;
   non-textual information, such as:
      a static image;
      an animated image;
      audio; and
      video; and
   interactive information; and
internal or hidden information, such as:
   a meta-tag;
   a metadata; and
   a comments.

Microsite

Herein a microsite or minisite has a separate uniform resource locator (URL) than the microsite's home page. A microsite is optionally a temporary site that is removed from one or more Web servers once information conveyed in the microsite is out of date and/or is no longer relevant. In one case, a microsite is an individual web page or cluster of web pages that function as discrete entities within an existing website. The microsite optionally has its own domain name or subdomain name.

A microsite is often used:
to provide an editorial or additional information on a specific topic;
provide a deep-dive into content rich and specific information on a specific topic;
to provide an opportunity for additional contextual advertising; and/or
to create keyword rich content to enhance search engine rankings on a specific topic.

Still referring to FIG. 1, generally a specific microsite contains a limited number of website elements. A set of microsites 120 often contain a subset of common website elements. As described, supra, updateable common microsite elements include: a string of text, microsite information, an image, an animation, a video, a banner, a background, a skin, and/or any other microsite graphical element.

Hub/Microsite Interrelationship

Still referring to FIG. 1, a hub/microsite updating system 100 is illustrated. The hub/microsite updating system 100 includes the hub 110 and the set of microsites 120 at least intermittently in communication with the hub 110.

Generally, the hub 110 is provided data 130 and the hub 110 is subsequently used to populate parameters or fields of a plurality of microsites 120. In this example, the hub 110 is illustrated as having a number of parameters 112, images/videos/animations 114, and/or locations 116 for presentation of the parameters 112 or images 114. However, generally the hub contains any combination of the data 130 or microsite elements described above. The set of microsites 120 is illustrated as a first microsite 122, a second microsite 124, and a third microsite 126. However, generally the set of microsites comprises n microsites where n is a positive integer, such as greater than 2, 10, 100, 1000, 10,000, 50,000 or 100,000. As illustrated, a first common image (I₁) from a hub image database 114 is automatically coded into and/or presented in the upper right hand corner of each of the first, second, and third microsites 122, 124, 126. The particular location of the first image is provided by a location field 116, where a location in the location field is optionally constant, varied across the microsites 120, and/or varied as a function of time. Similarly, a second common image (I₂) from the hub 110 image database 114 is automatically coded into and/or presented in the lower left hand corner of each of the first, second, and third microsites 122, 124, 126, where the second location is optionally provided by the location field 116. The parameter field 112 optionally contains a reference to any of the data types described above. In this example, text is provided in the third and fourth parameters memory locations (P₃, P₄) and the text from the third and fourth parameters memory locations is coded into and/or presented in the middle of each of the microsites 122, 124, 126, where again the position of the presentation of the text is optionally controlled using the location field 116 in the hub 110. Generally, any element of the microsites 120 is optionally controlled and/or updated by the hub 110. Preferably, information common to a plurality of the microsites 120 is controlled and/or updated using the data 130 provided to the hub 110.

Herein, without limitation and for clarity of presentation, examples of updating a set of car microsites and updating a set of microsites in different industries using a hub is described.

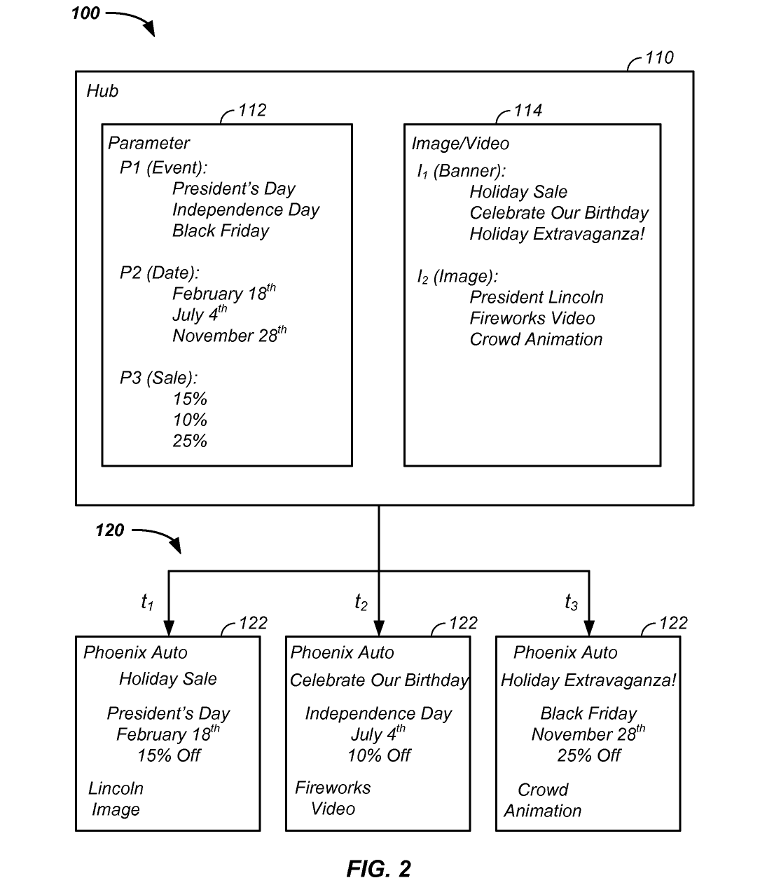

Referring now to FIG. 2, an example of use of the hub/microsite updating system 100 is illustrated. As illustrated, the hub 110 is used to update parameters for the first microsite 122 as a function of time. Particularly, the first microsite 122 is illustrated at a first time, t₁, a second time, t₂, and a third time, t₃. Generally, the first microsite 122 is updated by the hub at any time, hourly, multiple times within a day, daily, weekly, monthly, seasonally, or at particular times defined by the hub data, such as for particular holidays or sales events. In combination with use of hub 110 to update multiple microsites 120 described above, the hub 110 is optionally used to update and/or to automatically update the many microsites 120 as a function of time.

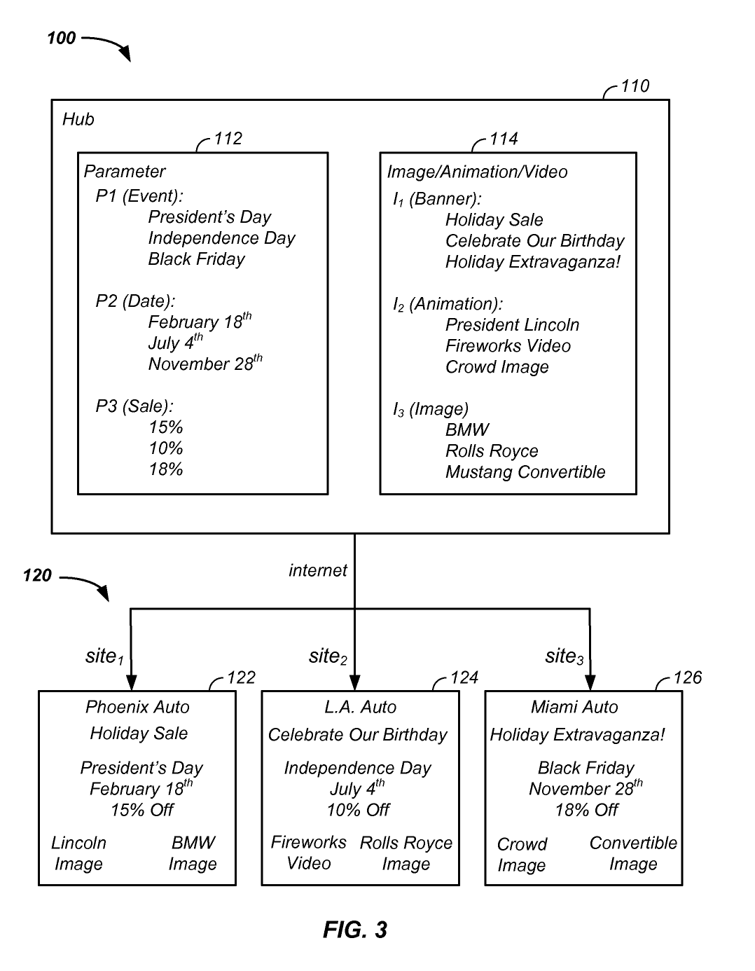

Referring now to FIG. 3, another example of use of the hub/microsite updating system 100 is illustrated. As illustrated, the hub 110 is used to update a set of microsites 120 in a single industry, where particular data 130 for individual microsites 122, 124, 126 varies. For example, the three microsites 122, 124, 126 present pages for three separate auto dealers in differing geographical locations where a different image of an advertised car is provided to each of the microsites 120 from the hub 110, such as based upon demographics of each geographical location and/or prior visitors to the individual microsites focused on a local product and/or service. In this example, it is observed that an image to a first car type is provided in the first microsite 122, an image of a second car type is provided in the second microsite 124, and an image of a third car type is provided in the third microsite 126. Generally, different data is optionally provided to each microsite by the hub 110 or specific data is provided to a multitude of the microsites but not to all of the microsites 120.

In combination with the process of updating the multiple microsites 120 using the hub 110 described above and the use of the hub 110 to update many microsites 120 as a function of time described above, the specific updating of particular microsites with individual data using the hub 110 results in:
updating a plurality of microsites 120 using the hub 110;
updating the microsites 120 as a function of time using the hub 110; and/or
providing individual content or data 130 to a subset of the microsites 120 using the hub 110,
   where the updating is optionally performed automatically using data in the database within the hub.

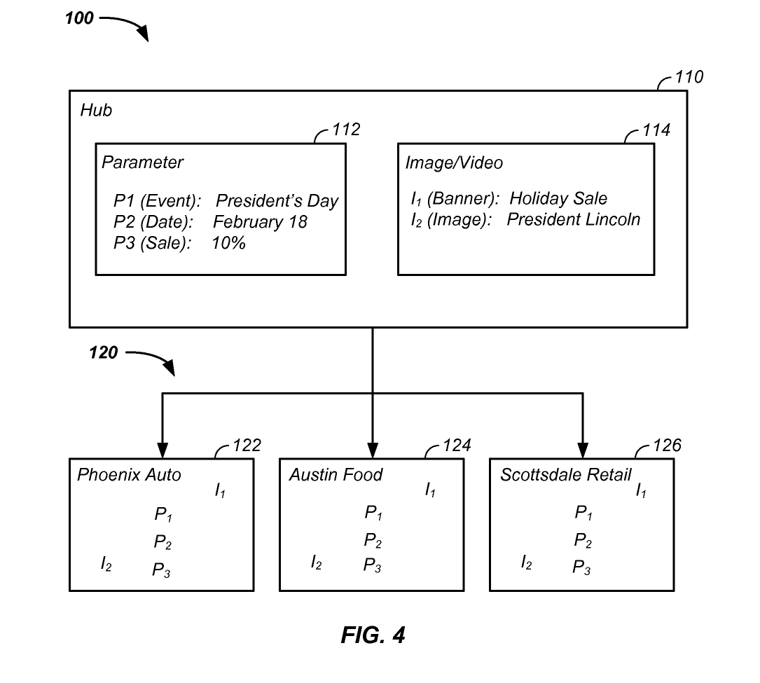

Referring now to FIG. 4, yet another example of use of the hub/microsite updating system 100 is illustrated. In this example, the hub 110 is used to update microsites 120 in a plurality of industries, such as the auto industry in the first microsite 122, the food industry in the second microsite 124, and the retail industry in the third microsite 126. Generally, the hub 110 is optionally used to update multiple microsites 120 in one or more industries, each optionally independently as a function of time, with individual images and/or data in an automated or semi-automated fashion.

Generally, any element, such as the rendered information and/or the hidden information, of any of the microsites 120 is optionally static, site specific, and not updateable by the hub 110 or is updatable by the hub 110. Optionally, individual microsites 120 are configured with tags readable by the hub 110, where the tags indicate fields intended to be updateable by the hub 110. The tags optionally include information used to indicate if the updateable parameter is an image, date, hidden parameter, animation, name, text, sale percentage, or the like.

Optionally, one microsite of a set of related microsites contains links to another microsite of the set of related microsites.

Optionally, a microsite, a set of related microsites, and/or a set of microsites is automatically deleted, such as after a single view by a user, after a set of n views by a specific user, after a set of n total views, and/or after an elapsed period of time, such as 1, 2, 3, 4, 5, 6, 7, 14, or 24 hours or days, where n is a positive integer.

Optionally a microsite, is optionally automatically deleted based upon a parameter graphically displayed in the microsite, such as:
a sale expiration date, such as a text or graphic stating sale ends Friday;
an end of a holiday, such as after President's day where a text or a graphic indicates the sale is on/through President's day; and/or
after a graphically represented time period, such as a graphic stating sale is for three days only.

Optionally, a microsite and/or a set of microsites are automatically deleted and/or altered based upon data contained in the database, such as the provided data 130 and/or any data used to populate a field of the microsite and/or the set of microsites.

Hardware

The hub 110 optionally uses a computer, mainframe, or server; a data storage medium; a user interface; means for data input; and any communication equipment to receive the data 130 and to relay the data to the microsites 120, such as via wireless communication, satellite, a computer network, and/or the internet.

Personalized Microsites

In another embodiment, micro-websites are automatically generated, updated, and/or deleted based upon user information, real-time information, and/or a timely event, such as a news event on an action, event, weather, or the like.

For example, the invention comprises a hub apparatus and method of use thereof for serving personalized advertisements and/or for serving/updating microsites, where a controller, programmer, automated code, and/or user updates a hub with a limited number of parameters for a subsequent broadcast, groupcast to a group having at least one commonality, and/or individualcast to an individual. For example, an individualcast and/or a user specific microsite is made to the individual user based upon an overlap of advertising parameters of the company with personal profile information of the individual or user as determined by a matching system. Optionally, the resulting advertisement is in the form of the personalized micro-website advertisement , such as delivered to the smart phone, personal computing device, personal computer, and/or to a personalized microsite.

Subsequent to identification of matching parameters of the personal profile information of the individual with advertising parameters of the company, a hub is optionally used to update parameters of a microsite and/or to generate a subject specific microsite. Examples of common updateable hub parameters include a piece of information, a location of the information, and/or a presentation of the information. The information is optionally to any piece of property or gizmo.

Preferably, the microsite is updated and/or generated based upon location and/or preferences of the individual relative to location and/or parameters of a product, good, event, or service offered by the company using personal profile information of the individual.

### Example I

A first non-limiting example of an individualcast is provided. In this example, the individual is driving past an auto dealer. Using the personal profile information of the individual and a communication system, such as in the individual's car, the smartphone, and/or a personal identification bracelet, an advertisement, in the form of a micro-website, from the company is served to the individual, such as through the communication system, smart phone, and/or personal computing device of the individual about presence of the car dealer, directions to the car dealer, a special offer of the car dealer, and/or information about a particular car of the car dealer. Preferably, the advertisement matches a subset of information in the personal profile information of the individual, such as the volunteered data of the personal data of the individual, which in this example is a particular car.

### Example II

A second non-limiting example of an individualcast is provided. In this example, the individual is at the auto dealer. Using the personal profile information of the individual and a communication system, such as the smartphone, the personal computing device of the individual, and/or the kiosk, an advertisement is served to the individual in the form of a micro-website. The micro-site is optionally to the particular car identified by the individual in the volunteered data or is an optional car, which the matching system identifies as both: (1) being available by the car dealer and (2) fulfills particular parameters of the individual based upon the personal profile information.

### Example III

In a third example, the company prepares a micro-website and serves a link to the micro-website or the microsite data to the individual based upon analysis of the matching system, analyzer, and/or controller using any information, such as stored on a chip or in the cloud, of the individual.

Personal Chip

In yet another embodiment, a personal identification device, such as the bracelet having a microchip or an embedded microchip is used to identify the person, is in communication with an auxiliary device or a remote system, and/or contains information about the individual, such as preferences of the individual.

Personal Web

In yet still another embodiment, a personal resource system is described. In the personal resource system one or more microsites are developed, created, and/or generated based on user specific information, such as stored on the personal chip, and are served to the individual, such as through a provided link or as directly as the micro-website. A personal web extractor system optionally continually, intermittently, and/or periodically updates one or more micro-websites tailored to a specific individual based upon the individual's stated interests, personal profile information, and/or data contained in a personal chip.

Virtual Microsites In another embodiment, a set of microsites are developed based on a user's profile, that are optionally shared with others, such as for a fee. The shared set of microsites optionally are generated on the fly and represent the life of an individual, such as a star, that others may follow.

Herein, a set of fixed numbers, such as 1, 2, 3, 4, 5, 10, or 20 optionally means at least any number in the set of fixed number and/or less than any number in the set of fixed numbers.

Still yet another embodiment includes any combination and/or permutation of any of the elements of any of the embodiments described herein.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

In the foregoing description, the invention has been described with reference to specific exemplary embodiments; however, it will be appreciated that various modifications and changes may be made without departing from the scope of the present invention as set forth herein. The description and figures are to be regarded in an illustrative manner, rather than a restrictive one and all such modifications are intended to be included within the scope of the present invention. Accordingly, the scope of the invention should be determined by the generic embodiments described herein and their legal equivalents rather than by merely the specific examples described above. For example, the steps recited in any method or process embodiment may be executed in any order and are not limited to the explicit order presented in the specific examples. Additionally, the components and/or elements recited in any apparatus embodiment may be assembled or otherwise operationally configured in a variety of permutations to produce substantially the same result as the present invention and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

Although the invention has been described herein with reference to certain preferred embodiments, one skilled in the art will readily appreciate that other applications may be substituted for those set forth herein without departing from the spirit and scope of the present invention. Accordingly, the invention should only be limited by the Claims included below.

1. A method for controlling micro-websites, comprising the steps of:
providing an updatable hub linked to a set of micro-websites, said updatable hub comprising a database and a digital controller;
determining common information to a first subset of microsites of the set of micro-websites;
subsequently, automatically populating fields of the first subset of microsites with the common information using said digital controller.

2. The method of claim 1, further comprising the step of:
repeating said steps of determining and automatically populating for at least an additional ten subsets of microsites of the set of micro-websites.

3. The method of claim 1, wherein the first set of micro-websites comprise entities within a main website domain of a first company.

4. The method of claim 1, wherein the first set of micro-websites comprise at least ten discreet microsite entities respectively linked to at least ten businesses website domains in one industry.

5. The method of claim 1, wherein the first set of micro-websites comprise microsites respectively within main website domains representing at least five industry types.

6. The method of claim 1, wherein said step of automatically updating the subset of microsites configures at least ten microsites using the common information, the common information comprising at least three of:
common graphical information;
common position information;
common textual information; and
common metadata information.

7. The method of claim 6, wherein said step of automatically updating the subset of microsites configures the at least ten microsites using the common information, the common information further comprising at least two of:
an animation;
a video; and
an audio track.

8. The method of claim 2, wherein said step of automatically updating updates the subset of microsites with a sale time period and at least one of:
a sale price; and
a discount.

9. The method of claim 8, said step of automatically updating configuring the subset of microsites with a physical location of a local store.

10. The method of claim 1, wherein said step of automatically updating further comprises:
updating visual content of at least one microsite of said first set of micro-websites as a function of time, wherein the content comprises microsite display format location information and at least one of: textual information linked to the display format location information and a graphic linked to the display format location information.

11. The method of claim 1, further comprising the step of:
linking said updatable hub to a second subset of microsites of the set of micro-websites, wherein said step of automatically updating updates said second set of micro-websites, wherein the first subset of microsites comprises microsites to a first industry, wherein the second subset of microsites comprises microsites to a second industry, wherein the first industry and the second industry comprise distinct industries.

12. The method of claim 11, wherein the first industry comprises any of: an auto industry, a banking industry, a food industry, a music industry, and a pharmaceutical industry; and
wherein the second industry comprises any of: an accounting industry, an agriculture industry, an apparel industry, a construction industry, and a travel industry.

13. The method of claim 1, further comprising the step of:
automatically generating a company micro-website linked to a company website domain, said step of automatically generating populating the company micro-website with information from the database, said company micro-website comprising a member of the set of micro-websites.

14. The method of claim 13, wherein said step of automatically generating a company micro-website repeats at least n times based upon a real-time visit of a site mapping web-crawling spider bot, wherein n is a positive integer of at least two.

15. The method of claim 1, further comprising the step of:
automatically generating in real-time a user specific microsite based on user information, said user specific microsite comprising a member of the set of micro-websites.

16. The method of claim 15, wherein the user information contains profile information on the user.

17. The method of claim 16, wherein the step of automatically generating the user specific microsite comprises use of user profile information gathered during a current visit of the user to a company website domain within a prior five minute time period.

18. The method of claim 15, wherein the user information contains data in a personal identification chip.

19. The method of claim 15, further comprising the step of:
automatically deleting the user specific microsite within one week after departure of the user from the company website domain.

20. The method of claim 1, further comprising the step of:
automatically deleting the first subset of microsites based on time related data in said database.

21. An apparatus for controlling micro-websites, comprising:
an updatable hub linked to a set of micro-websites, said updatable hub comprising a database and a digital controller, said controller configured to determine common information to a first subset of microsites of the set of micro-websites, said controller configured to, subsequently, automatically populate fields of the first subset of microsites with the common information using said digital controller.
